(19) United States
(12) Patent Application Publication
(10) Pub. No.: US 2025/0358774 A1
(43) Pub. Date: Nov. 20, 2025

(54) WEIGHTING POSITIONING MEASUREMENTS

(71) Applicant: Nokia Technologies Oy, Espoo (FI)

(72) Inventors: Anil KIRMAZ, Munich (DE); Taylan SAHIN, Munich (DE); Diomidis MICHALOPOULOS, Munich (DE)

(21) Appl. No.: 18/871,621

(22) PCT Filed: Jul. 18, 2023
(86) PCT No.: PCT/FI2023/050443

§ 371 Date: Dec. 4, 2024

(30) Foreign Application Priority Data
Aug. 10, 2022 (FI) 20225712

(51) Int. Cl. H04W 64/00

(52) U.S. Cl. CPC H04W 64/00

(57) ABSTRACT

According to example embodiments of the present disclosure, a method for weighting positioning measurements is proposed. A difference between a measurement and a reference value is determined based on one or more channel features associated with the measurement and the reference value. A weight for the measurement is determined based on the difference between the measurement and the reference value. In this way, positioning accuracy can be improved. Moreover, it does not require multiple measurements when assigning the weight for the measurement.

### FIELD

Various example embodiments of the present disclosure generally relate to the field of telecommunication and in particular, to methods, devices, apparatuses and computer readable storage medium for weighting positioning measurements.

### BACKGROUND

Location-awareness is a fundamental aspect of wireless communication networks and will enable a myriad of location-enabled services in different applications. The integration and utilization of location information in day-to-day applications will grow significantly as the technology's accuracy evolves.

Many positioning technologies have been proposed, such time of arrival (TOA), time difference of arrival (TDOA), round trip time (RTT), angle of arrival (AOA), and angle of departure (AOD). Position estimation may be conducted using multiple positioning measurements taken from differently located anchors or Transmission Reception Points (TRPs) in both time-based and angle-based methods. Such multiple measurements are then combined to estimate position of user equipment (UE).

### SUMMARY

In a first aspect of the present disclosure, there is provided a first device. The first device comprises at least one processor; and at least one memory storing instructions that, when executed by the at least one processor, cause the first device at least to: determine a set of channel features and a set of reference values associated with the set of channel features;

determine at least one target channel feature from a target positioning measurement based on the set of channel features; determine a difference between the target positioning measurement and at least one reference value in the set of reference values based on the at least one target channel feature; and determine a weight for the target positioning measurement based on the difference.

In a second aspect of the present disclosure, there is provided a method. The method comprises determining a set of channel features and a set of reference values associated with the set of channel features. The method also comprises determining at least one target channel feature from a target positioning measurement based on the set of channel features. The method further comprises determining a difference between the target positioning measurement and at least one reference value in the set of reference values based on the at least one target channel feature. The method also comprises determining a weight for the target positioning measurement based on the difference.

In a third aspect of the present disclosure, there is provided a first apparatus. The first apparatus comprises: means for determining a set of channel features and a set of reference values associated with the set of channel features; means for determining at least one target channel feature from a target positioning measurement based on the set of channel features; means for determining a difference between the target positioning measurement and at least one reference value in the set of reference values based on the at least one target channel feature; and means for determining a weight for the target positioning measurement based on the difference.

In a fourth aspect of the present disclosure, there is provided a computer readable medium. The computer readable medium comprises instructions stored thereon for causing an apparatus to perform at least the method according to the first aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a flowchart of a process for weighting a positioning measurement according to some example embodiments of the present disclosure;

FIG. 3 illustrates a signaling chart for communication according to some example embodiments of the present disclosure;

FIG. 4 illustrates a schematic diagram of determining a difference between the positioning measurement and one or more reference values according to some example embodiments of the present disclosure;

FIG. 5 illustrates a simplified block diagram of a device that is suitable for implementing example embodiments of the present disclosure; and

FIG. 6 illustrates a block diagram of an example computer readable medium in accordance with some example embodiments of the present disclosure.

Throughout the drawings, the same or similar reference numerals represent the same or similar element. Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>”

and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Example embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom.

The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As mentioned above, position estimation may be conducted using multiple positioning measurements taken from differently located anchors or TRPs in both time-based and angle-based methods. Positioning accuracy may be directly affected by the accuracy of each utilized time-based or angle-based positioning measurement. However, each measurement may be usually associated with a different radio environment and, thereby, does not have the same reliability for the positioning task.

While some of the measurements can carry accurate information, some other might be inaccurate due to challenging radio conditions such as non-line-of-sight (NLOS) or multipath propagation. When inaccurate measurements are included in the positioning solution, the accuracy of the final location estimate may be degraded. As an example, the case of NLOS measurements has been a known problem since the flight time of signals over NLOS paths is not associated with the distance from Transmitter to Receiver, thereby distorting the location estimate. Therefore, solutions are needed to mitigate such measurement inaccuracies.

In order to mitigate the negative effect of inaccurate positioning measurements on the final location estimation, each positioning measurement may be evaluated in terms of accuracy and reliability. Although received power can be used for such evaluation as a simple scheme, relying only on the received power results in a very limited information extraction for positioning purposes. For time-based and angle-based positioning methods NLOS propagation is one of the major sources of accuracy degradation. Therefore, evaluating accuracy of the positioning measurements based on classifying the propagation condition, i.e., line-of-sight (LOS) or NLOS, attracted interest and shown to be efficient. According to some solutions, discarding NLOS classified samples from positioning, i.e., utilizing only LOS classified measurements for positioning may be considered. However, when the number of available measurements is low, this approach can result in inaccurate positioning.

According to some other solutions, another approach is to include NLOS measurements in the positioning solution by introducing a weighting procedure. In this way, lower weights can be assigned to e.g., NLOS-like measurements where higher weights can be assigned to e.g., LOS-like measurements. The weighting can be applied to positioning by applying a weighted least squares (WLS) estimator instead of a least squares (LS) estimator. The mentioned LOS/NLOS indicator that can be reported. However, how to obtain such indicator is not specified. Various features extracted from received positioning signals are processed by likelihood tests, support vector machines and Gaussian processes or fuzzy comprehensive evaluation to determine the weights. Furthermore, ranging error estimated from a channel impulse response (CIR) by a deep learning algorithm may be utilized to weight each ranging measurement in positioning solution. However, such methods also require labeled (with LOS/NLOS flags or with ranging error) data to train the adopted supervised methods where collecting labeled data for each scenario of interest, and updating the labels whenever a relevant scenario undergoes significant changes can be costly due to the required labor and time.

### Example Environment

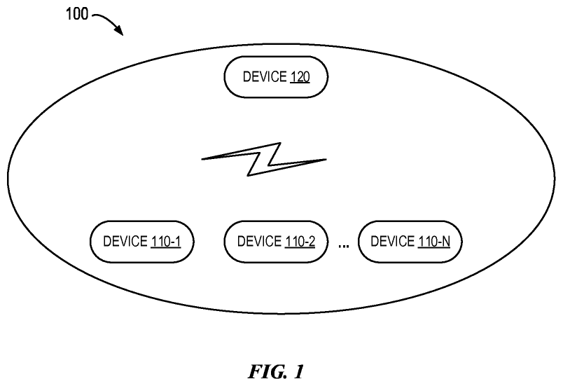

FIG. 1 illustrates an example communication environment 100 in which example embodiments of the present disclosure can be implemented. The communication environment 100 includes a device 110-1, a device 110-2, . . . , a device 110-N, which can be collectively referred to as “device(s) 110” and N can be any integer. The communication environment 100 also includes a device 120. In the communication environment 100, a plurality of communication devices, including the device 110 and the device 120, can communicate with each other.

It is to be understood that the number of devices and their connections shown in FIG. 1 are only for the purpose of illustration without suggesting any limitation. The communication environment 100 may include any suitable number of devices configured to implementing example embodiments of the present disclosure. It is noted that although illustrated as a core network device, the device 120 may be other device than a core network device. Although illustrated as a terminal device, the device 110 may be other device than a terminal device.

In the following, for the purpose of illustration, some example embodiments are described with the device 110 operating as a terminal device and the device 120 operating as a core network device. However, in some example embodiments, operations described in connection with a terminal device may be implemented at a network device or other device, and operations described in connection with a network device may be implemented at a terminal device or other device.

In some example embodiments, if the device 110 is a terminal device, a link from s network device to the device 110 is referred to as a downlink (DL), while a link from the device 110 to the network device is referred to as an uplink (UL). In some example embodiments, the device 120 may be a transmitting (TX) device (or a transmitter) and the device 110 may be a receiving (RX) device (or a receiver). In some other embodiments, the device 110 may be a TX device (or a transmitter) and the device 120 may be a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

### Work Principle and Example Methods

According to example embodiments of the present disclosure, a method for weighting positioning measurements is proposed. A difference between a measurement and a reference value is determined based on one or more channel features associated with the measurement and the reference value. A weight for the measurement is determined based on the difference between the measurement and the reference value. In this way, positioning accuracy can be improved. Moreover, it does not require multiple measurements when assigning the weight for the measurement.

Example embodiments of the present disclosure will be described in detail below with reference to the accompanying drawings.

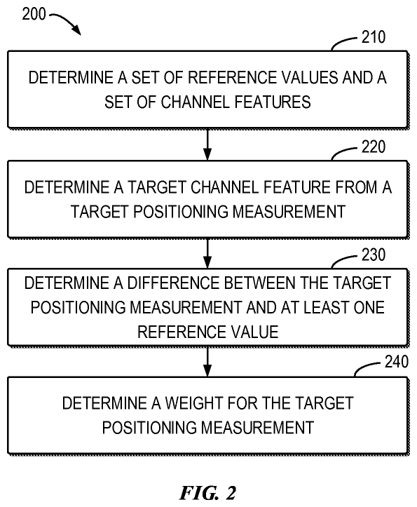

FIG. 2 shows a flowchart of an example method 200 implemented at a first device in accordance with some example embodiments of the present disclosure. In some example embodiments, the first device may refer to the device 110. Alternatively, the first device may refer to the device 120.

At block 210, the first device determines a set of channel features and a set of reference values associated with the set of channel features. In some example embodiments, the first device may determine the set of reference values and the set of channel features by itself. For example, if the first device refers to the device 120, the device 120 may determine the set of reference values and the set of channel features by itself. Alternatively, the first device may receive first information indicating at least one of: the set of reference values and the set of channel features from a second device. For example, in some example embodiments, the first device may refer to the device 110-1 and the second device may refer to the device 120. In this case, the device 120 may determine the set of reference values and the set of channel features and transmit the first information indicating the set of reference values and the set of channel features to the device 110-1. In some example embodiments, the device 110-1 may transmit a request for at least one of: the set of reference values and the set of channel features to the device 120 and the device 120 may transmit the first information based on the request. For example, in some example embodiments, the device 110-1 may request both the set of reference values and the set of channel features. In this case, the device 110-1 may receive the first information indicating both the set of reference values and the set of channel features. Alternatively, the set of channel features may be predetermined or prefunded. In this case, the device 110-1 may request the set of reference values and receive the first information indicating the set of reference values.

In some example embodiments, the set of reference values and the set of channel features may be determined during offline phase. In this case, in some example embodiments, the first device may collect channel measurement information related to a set of measurements. In some example embodiments, the set of measurements may comprise one or more time-based positioning measurements. For example, the set of measurements may comprise one or more of: TOA, TDOA, or RTT. Alternatively, or in addition, the set of measurements may comprise one or more angle-based measurements. For example, the set of measurements may comprise one or more of: AOA or AOD. The channel measurement information may include one or more types of information that are useful in characterizing the communication channel. In some example embodiments, the channel measurement information may include a channel impulse response (CIR), channel status information (CSI), Received Signal Strength Indicator (RSSI), Reference Signal Received Power (RSRP), and/or other information that can be measured. In some example embodiments, the set of measurements may comprise uplink measurements. Alternatively, the set of measurements may comprise downlink measurements. In some other example embodiments, the set of measurements may comprise sidelink measurements.

In some example embodiments, the first device may determine a set of channel features from the set of measurements. For example, the first device may extract one or more channel features that behave different for LOS propagation and NLOS propagation from the collected channel measurement information. In some example embodiments, the set of channel features may comprise root mean square (RMS) delay spread. For example, the RMS delay spread may be lower for LOS propagation than NLOS propagation. Alternatively, or in addition, the set of channel features mat comprise a channel response amplitude (for example, a maximum channel response amplitude). For example, the maximum channel response amplitude may be larger for the LOS propagation than the NLOS propagation. In some other embodiments, the set of channel features may comprise channel response rise time. For example, the channel response rise time may be shorter for the LOS propagation than the NLOS propagation. Alternatively, or in addition, the set of channel features may comprise a Rician K factor. For example, the Rician K factor may be higher for the LOS propagation than the NLOS propagation. It is noted that the set of channel features may comprise one or any combination of the above-mentioned channel feature and the set of channel features may also comprise one or more of other channel features not mentioned above.

In some example embodiments, the first device may cluster the set of measurements into a number of classes based on the set of channel features. For example, the set of measurements may be clustered into K classes based on the set of channel features, where K may be an integer number. In addition, the first device may determine the set of reference values for the classes. For example, centroids of the K classes may be determined. In some example embodiments, the K clusters may be ordered with respect to (N) LOS-likeness of their centroid coordinates. For example, a centroid with a higher delay spread and a lower Rician K-factor may be a more NLOS-like cluster. As a result of the offline phase, the set of channel features and the set of reference values for classes can be obtained.

In some example embodiments, a contradiction check may be performed on the set of reference values. In this way, the clusters do not contradict with each other for LOS-likeness or NLOS likeness. For example, a cluster cannot have a higher channel response kurtosis (implying more LOS-likeness) and higher delay spread (implying less LOS-likeness) simultaneously than another cluster.

At block 220, the first device determines at least one target channel feature from a target positioning measurement based on the set of channel features. In some example embodiments, the target positioning measurement may comprise a time-based positioning measurement. For example, the target positioning measurement may comprise one of: TOA, TDOA, or RTT. Alternatively, or in addition, the target positioning measurement may comprise an angle-based measurements. For example, the target positioning measurement may comprise one of: AOA or AOD. In some example embodiments, if the set of channel features comprise a first channel feature, the first device may determine the first channel feature of the target positioning measurement. Only as an example, if the set of channel features comprise a channel response amplitude, the first device may determine the channel response amplitude of the target positioning measurement. Alternatively, if the set of channel features comprise multiple channel features, the first device may determine the multiple channel features of the target positioning measurement. For example, if the set of channel features comprise the channel response amplitude and a delay spread, the first device may determine the channel response amplitude and the delay spread of the target positioning measurement. In some example embodiments, the set of channel features may comprise one or more of: a receive waveform amplitude, a received waveform rise time, a received waveform kurtosis, an average energy of a channel response, an average energy of a received waveform, a total energy of the channel response, a total energy of the received waveform, a total amplitude of the channel response, a total amplitude of received waveform, a mean excess delay, a skewness of the channel response, a skewness of the received waveform, a standard derivation of the channel response, a standard derivation of the received waveform, a standard variance of the channel response, or a standard variance of the received waveform.

At block 230, the first device determines a difference between the target positioning measurement and at least one reference value based on the at least one target channel feature. For example, the difference may be determined as dᵢ=|O−Cⱼ|ₗ, where d represents the difference, i={LOS,NLOS} for j={1,2}, Cⱼ represents the j^{th} reference value and O represents a value of the target feature of the target positioning measurement.

In some example embodiments, the first device may determine the difference between the target positioning measurement and one reference value. Alternatively, the first device may determine the differences between the target positioning measurement and more than one reference value. In some example embodiments, the first device may determine the differences between the target positioning measurement and a subset of reference values. For example, if the set of reference values have two references values, a first reference value associated with LOS channel (or LOS radio propagation condition) and a second reference value associated with NLOS channel (or NLOS radio propagation condition) may be used. In this case, the first device may determine a first difference (for example, represented as d_{LOS}) between the target positioning measurement and the first reference value and determine a second difference (for example, represented as d_{NLOS}) between the target positioning measurement and the second reference value. The term “line-of-sight (LOS)” used herein can refer to a type of propagation that can transmit and receive data only where transmit and receive stations are in view of each other without any sort of an obstacle between them.

In some embodiments, the first device may determine, from the set of reference values, a third reference value which is associated with a more line-of-sight-like channel than other reference values in the set of reference values. The first device may also determine, from the set of reference values, a fourth reference value which is associated with a more non-line-of-sight-like channel than other reference values in the set of reference values. In this case, the first device may determine a third difference between the target positioning measurement and the third reference value and determine a fourth difference between the target positioning measurement and the fourth reference value. In other words, if the set of reference values have more than two reference values, one reference value associated with a more LOS like channel and another reference value associated with a more NLOS like channel may be used for determining the differences. Alternatively, in some example embodiments, the first device may determine differences between the target positioning measurement and or a plurality of reference values (for example all reference values) in the set of reference values. In other words, all of or a plurality of reference values in the set of reference values may be used to determine the differences. For example, if the set of reference values comprises 5 reference values, the difference between the target positioning measurement and each of the 5 reference values may be calculated. In this case, 5 differences may be obtained. The term “LOS like channel” used herein can refer to a channel that has a propagation which is similar to or same as the LOS. The term “NLOS like channel” used herein can refer to a channel that has a propagation which different from the LOS.

In some example embodiment, the target positioning measurement may comprise a measurement related to uplink. Alternatively, the target positioning measurement may comprise a measurement related to downlink. In some other embodiments, the target positioning measurement may comprise a measurement related to sidelink. In this case, for example, the target positioning measurement may be conducted on reference signals transmitted over sidelink (for example, between the first device and an anchor UE(s)). Alternatively, or in addition, the target positioning measurement may be conducted on reference signals received over sidelink.

At block 240, the first device determines a weight for the target positioning measurement based on the difference(s). For example, if the first difference is smaller than the second difference, the target positioning measurement may be assigned with a first weight. If the first difference is larger than the second difference, the target positioning measurement may be assigned with a second weight. In this case, the first weight may be larger than the second weight. In other words, a positioning measurement closer to the most LOS-like centroid and away from the most NLOS-like centroid may result in a high weight while a positioning measurement away from the most LOS-like centroid and closer to the most NLOS-like centroid may result in a low weight. Alternatively, in some example embodiments, all reference values or a plurality of reference values in the set of reference values may be used for determining the differences. In this case, the weight may be determined based on all of the differences. For example, if the set of reference values comprises 5 reference values, the difference between the target positioning measurement and each of the 5 reference values may be calculated. In this case, the weight may be determined based on the obtained 5 differences.

In some example embodiments, the first device may determine the weight as a function of the difference. For example, the weight may be determined as w=f(d_{LOS}, d_{NLOS}), where w represents the weight, f represents the weight function, d_{LOS} represents the first difference between the target positioning measurement and the first reference value associated with LOS, and d_{NLOS} represents the second difference between the target positioning measurement and the second reference value associated with NLOS. In some example embodiments, the function f may be chosen such that the weight w becomes larger as d_{LOS} gets smaller and as d_{NLOS} gets larger. It is noted that example embodiments of the present disclosure are not limited to K=2 clusters and K can take any integer value greater than 1 and the number of channel features can be arbitrarily chosen.

In some example embodiments, the function may include a ratio between the first difference and the second difference, for example, d_{LOS}/d_{NLOS}. Alternatively, the function may include a ratio between the first difference and a sum of the first and second differences, for example, d_{LOS}/(d_{LOS}+d_{NLOS}). In some other embodiments, the function may include a ratio between the second difference and a sum of the first and second differences, for example, d_{NLOS}/(d_{LOS}+d_{NLOS}). In some example embodiments, the function may include a ratio between the first difference and a difference between the first and second differences, for example, d_{LOS}/(d_{LOS}−d_{NLOS}). In some other embodiments, the function may include a ratio between the second difference and a difference between the first and second differences, for example, d_{NLOS}/(d_{LOS}−d_{NLOS}). Alternatively, the function may include a ratio between the first difference and an absolute sum of the first and second differences, for example, d_{LOS}/|d_{LOS}+d_{NLOS}|. Alternatively, the function may include a ratio between the second difference and an absolute sum of the first and second differences, for example, d_{NLOS}/|d_{LOS}+d_{NLOS}|. Alternatively, the function may include a ratio between the sum of the first and second differences and a difference of the first and second differences, for example, (d_{LOS}−d_{NLOS})/|d_{LOS}+d_{NLOS}|.

In some example embodiments, the function may include a ratio between functions of the first difference and the second difference, for example, logd_{LOS}/logd_{NLOS} or expd_{LOS}/expd_{NLOS}. Alternatively, the function may include a ratio between functions of the first difference and a sum of the first and second differences, for example, logd_{LOS}/log(d_{LOS}+d_{NLOS}) or expd_{LOS}/exp(d_{LOS}+d_{NLOS}). In some other embodiments, the function may include a ratio between functions of the second difference and a sum of the first and second differences, for example, logd_{NLOS}/log(d_{LOS}+d_{NLOS}) or expd_{NLOS}/exp(d_{LOS}+d_{NLOS}). In some example embodiments, the function may include a ratio between functions of the first difference and a difference between the first and second differences, for example, logd_{LOS}/log(d_{LOS}−d_{NLOS}) or expd_{LOS}/exp(d_{LOS}−d_{NLOS}). In some other embodiments, the function may include a ratio between functions of the second difference and a difference between the first and second differences, for example, logd_{NLOS}/log(d_{LOS}−d_{NLOS}) or expd_{NLOS}/exp(d_{LOS}−d_{NLOS}). Alternatively, the function may include a ratio between functions of the first difference and an absolute sum of the first and second differences, for example, logd_{LOS}/log|d_{LOS}+d_{LOS}| or expd_{LOS}/exp|d_{LOS}+d_{NLOS}|. Alternatively, the function may include a ratio between functions of the second difference and an absolute sum of the first and second differences, for example, logd_{NLOS}/log|d_{LOS}+d_{NLOS}| or expd_{NLOS}/exp|d_{LOS}+d_{NLOS}|. Alternatively, the function may include a ratio between functions of the sum of the first and second differences and a difference of the first and second differences, for example, log(d_{LOS}−d_{NLOS})/log|d_{LOS}+d_{NLOS}| or exp(d_{LOS}−d_{NLOS})/exp|d_{LOS}+d_{NLOS}|.

In some example embodiments, the first device may determine a position estimation based on the weight. For example, the first device may determine the position estimation by using a weighted least squared algorithm. Alternatively, the first device may transmit second information indicating the weight for determining the position estimation to the second device.

According to example embodiments of the present disclosure, the first device (i.e., the weighting entity, for example, the device 110 or the device 120) may utilize the set of reference values belonging to previously determined clusters of positioning measurements, and a poisoning measurement to be weighted as input, and produce the weight of the given measurement as output to be used in positioning estimation. In this way, during the online phase, example embodiments of the present disclosure may not require multiple measurements to determine the weights of positioning measurements. Moreover, the accuracy of positioning may also be improved.

### Example Signaling for Communication

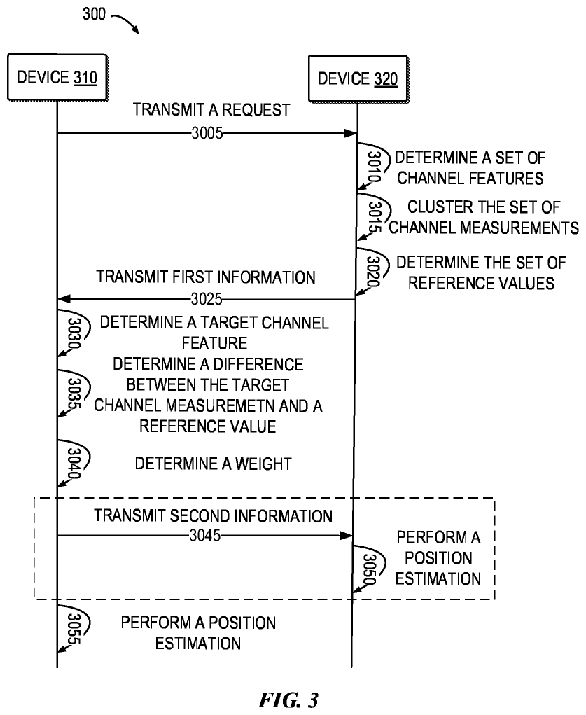

Reference is now made to FIG. 3, which shows a signaling chart 300 for communication according to some example embodiments of the present disclosure. As shown in FIG. 3, the signaling chart 300 involves a device 310 and a device 320. In some example embodiments, the device 310 may be implemented as one of the devices 110 (for example, the device 110-1) shown in FIG. 1 and the device 320 may be implemented as the device 120 shown in FIG. 1. In this case, in some example embodiments, the signaling may be via LTE positioning protocol (LPP) provide assistance data message from the device 120 to the device 110-1. In some other example embodiments, the signaling may be first via NR positioning protocol a (NRPPa) provide assistance data from the device 120 to a network device (for example, gNB) and then may be transmitted to the device 110-1 via a radio resource control (RRC) message or a medium access control (MAC) message. Alternatively, the device 310 may be implemented as one of the devices 110 (for example, the device 110-1) and the device 320 may be implemented as the other one of the devices 110 (for example, the device 110-2). In this case, the signaling may be via sidelink between the devices 110.

Although one device 310 and one device 320 are illustrated in FIG. 3, it would be appreciated that there may be a plurality of devices performing similar operations as described with respect to the device 310 below and a plurality of devices performing similar operations as described with respect to the device 320 below. It is noted that the signaling shown in FIG. 3 is only an example not limitation.

In some example embodiments, the device 310 may transmit 3005 a request for at least one of: a set of reference values and a set of channel features to the device 320. For example, the device 310 may request a set of centroid feature vector values to be used. For example, in some example embodiments, the device 310 may request both the set of reference values and the set of channel features. Alternatively, the set of channel features may be predetermined or prefunded. In this case, the device 310 may request the set of reference values.

In some example embodiments, the set of reference values and the set of channel features may be determined during offline phase. In this case, in some example embodiments, the device 320 may collect channel measurement information related to a set of measurements. In some example embodiments, the set of measurements may comprise one or more time-based positioning measurements. For example, the set of measurements may comprise one or more of: TOA, TDOA, or RTT. Alternatively, or in addition, the set of measurements may comprise one or more angle-based measurements. For example, the set of measurements may comprise one or more of: AOA or AOD. The channel measurement information may include one or more types of information that are useful in characterizing the communication channel. In some example embodiments, the channel measurement information may include a channel impulse response (CIR), channel status information (CSI), Received Signal Strength Indicator (RSSI), Reference Signal Received Power (RSRP), and/or other information that can be measured. In some example embodiments, the set of measurements may comprise uplink measurements. Alternatively, the set of measurements may comprise downlink measurements. In some other example embodiments, the set of measurements may comprise sidelink measurements.

The device 320 may determine 3010 a set of channel features based on a set of measurements. For example, the device 320 may extract one or more channel features that behave different for LOS propagation and NLOS propagation from the collected channel measurement information. In some example embodiments, the set of channel features may comprise root mean square (RMS) delay spread. For example, the RMS delay spread may be lower for LOS propagation than NLOS propagation. Alternatively, or in addition, the set of channel features mat comprise a channel response amplitude (for example, a maximum channel response amplitude). For example, the maximum channel response amplitude may be larger for the LOS propagation than the NLOS propagation. In some other embodiments, the set of channel features may comprise channel response rise time. For example, the channel response rise time may be shorter for the LOS propagation than the NLOS propagation. Alternatively, or in addition, the set of channel features may comprise a Rician K factor. For example, the Rician K factor may be higher for the LOS propagation than the NLOS propagation. It is noted that the set of channel features may comprise one or any combination of the above-mentioned channel feature and the set of channel features may also comprise one or more of other channel features not mentioned above. In some example embodiments, the set of channel features may comprise one or more of: a root mean square delay spread, a channel response or received waveform amplitude, a channel response or received waveform rise time, a channel response or received waveform kurtosis, a Rician K factor, an average energy of a channel response or received waveform, a total energy of the channel response or received waveform, an average amplitude of the channel response or received waveform, a total amplitude of the channel response or received waveform, a mean excess delay, a skewness of the channel response or received waveform, a standard deviation of the channel response or received waveform, or a standard variance of the channel response or received waveform.

In some example embodiments, the device 320 may cluster 3015 the set of measurements into a number of classes based on the set of channel features. For example, the set of measurements may be clustered into K classes based on the set of channel features, where K may be an integer number.

In addition, the device 320 may determine 3020 the set of reference values for the classes. For example, centroids of the K classes may be determined. In some example embodiments, the K clusters may be ordered with respect to (N) LOS-likeness of their centroid coordinates. For example, a centroid with a higher delay spread and a lower Rician K-factor may be a more NLOS-like cluster. As a result of the offline phase, the set of channel features and the set of reference values for classes can be obtained.

In some example embodiments, a contradiction check may be performed on the set of reference values. In this way, the clusters do not contradict with each other for LOS-likeness or NLOS likeness. For example, a cluster cannot have a higher channel response kurtosis (implying more LOS-likeness) and higher delay spread (implying less LOS-likeness) simultaneously than another cluster.

The device 320 may transmit 3025 first information indicating at least one of: the set of reference values and the set of channel features to the device 310. For example, the device 320 may provide the channel features and K centroid feature vector values to the device 310. For example, if the device 310 requests both the set of reference values and the set of channel features, the first information may indicate both the set of reference values and the set of channel features. Alternatively, the set of channel features may be predetermined or prefunded. In this case, the device 110-1 may request the set of reference values and receive the first information indicating the set of reference values.

The device 310 may determine 3030 a target channel feature from a target positioning measurement based on the set of channel features. In some example embodiments, the target positioning measurement may comprise a time-based positioning measurement. For example, the target positioning measurement may comprise one of: TOA, TDOA, or RTT. Alternatively, or in addition, the target positioning measurement may comprise an angle-based measurements. For example, the target positioning measurement may comprise one of: AOA or AOD.

In some example embodiments, if the set of channel features comprise a first channel feature, the first device may determine the first channel feature of the target positioning measurement. Only as an example, if the set of channel features comprise a channel response amplitude, the first device may determine the channel response amplitude of the target positioning measurement. Alternatively, if the set of channel features comprise multiple channel features, the first device may determine the multiple channel features of the target positioning measurement. For example, if the set of channel features comprise the channel response amplitude and a delay spread, the first device may determine the channel response amplitude and the delay spread of the target positioning measurement. In some example embodiments, the set of channel features may comprise one or more of: a delay spread, CIR or received waveform energy, channel response or received waveform kurtosis, a maximum channel response or received waveform amplitude, channel response or received waveform rise time, or a Rician K-factor.

In some example embodiment, the target positioning measurement may comprise a measurement related to uplink. Alternatively, the target positioning measurement may comprise a measurement related to downlink. In some other embodiments, the target positioning measurement may comprise a measurement related to sidelink. In this case, for example, the target positioning measurement may be conducted on reference signals transmitted over sidelink (for example, between the first device and an anchor UE(s)). Alternatively, or in addition, the target positioning measurement may be conducted on reference signals received over sidelink.

The device 310 may determine 3035 a difference between the target positioning measurement and at least one reference value. For example, the difference may be determined as dᵢ=|O−Cⱼ|ₗ, where d represents the difference, i={LOS,NLOS} for j={1,2}, Cⱼ represents the j^{th} reference value (i.e., the j^{th} centroid vector) and O represents a value of the target feature (i.e., the feature vector) of the target positioning measurement. The length of the vectors may be determined by the number of features extracted from the positioning measurement.

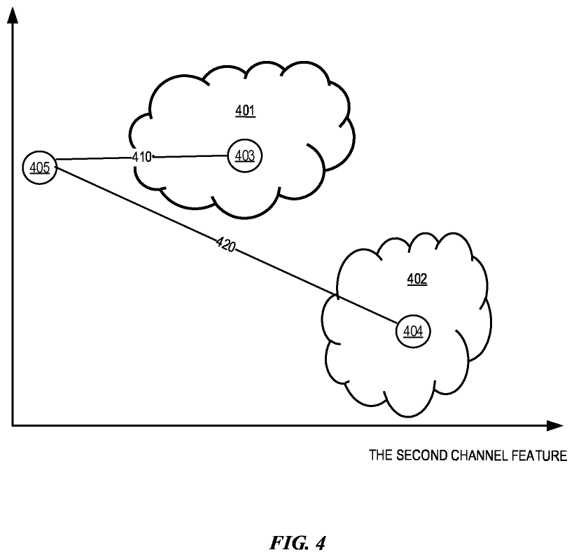

Referring to FIG. 4, the set of channel features may comprise the first channel feature and the second channel feature. Only as an example, the first channel feature may be a maximum channel response amplitude and the second channel feature may be a RMS delay spread. As shown in FIG. 4, the cluster 401 may have a larger value of the first channel feature than the cluster 402 and a smaller value of the second channel feature than the cluster 402. For example, the cluster 401 may be associated with LOS propagation and the cluster 402 may be associated with NLOS propagation. In this case, the cluster 401 may have a larger maximum channel response amplitude than the cluster 402 and a smaller RMS delay spread than the cluster 402. The cluster 401 may have a centroid 403 (i.e., the first reference value) and the cluster 402 may have a centroid 404 (i.e., the second reference value). The device 310 may determine the first difference between the positioning measurement 405 and the centroid 403 and the second difference between the positioning measurement 405 and the centroid 404. For example, the device 310 may calculate the distance 410 between the positioning measurement 405 and the centroid 403. The device 310 may also calculate the distance 420 between the positioning measurement 405 and the centroid 404.

Referring back to FIG. 3, the device 310 may determine 3040 a weight for the target positioning measurement based on the difference. For example, as shown in FIG. 4, the weight for the positioning measurement 405 may be determined based on the distance 410 and the distance 420. In some example embodiments, the weight may be determined as w=f(d_{LOS}, d_{NLOS}), where w represents the weight, f represents the weight function, d_{LOS} represents the first difference between the target positioning measurement and the first reference value associated with LOS, and d_{NLOS} represents the second difference between the target positioning measurement and the second reference value associated with NLOS. In some example embodiments, the function f may be chosen such that the weight w becomes larger as dos gets smaller and as d_{NLOS} gets larger.

In some example embodiments, the function may include a ratio between the first difference and the second difference. Alternatively, the function may include a ratio between the first difference and a sum of the first and second differences. In some other embodiments, the function may include a ratio between the second difference and a sum of the first and second differences. In some example embodiments, the function may include a ratio between the first difference and a difference between the first and second differences. In some other embodiments, the function may include a ratio between the second difference and a difference between the first and second differences. Alternatively, the function may include a ratio between the first difference and an absolute sum of the first and second differences. Alternatively, the function may include a ratio between the second difference and an absolute sum of the first and second differences. Alternatively, the function may include a ratio between the sum of the first and second differences and a difference of the first and second differences.

In some example embodiments, the function may include a ratio between functions of the first difference and the second difference. Alternatively, the function may include a ratio between functions of the first difference and a sum of the first and second differences. In some other embodiments, the function may include a ratio between functions of the second difference and a sum of the first and second differences. In some example embodiments, the function may include a ratio between functions of the first difference and a difference between the first and second differences. In some other embodiments, the function may include a ratio between functions of the second difference and a difference between the first and second differences. Alternatively, the function may include a ratio between functions of the first difference and an absolute sum of the first and second differences. Alternatively, the function may include a ratio between functions of the second difference and an absolute sum of the first and second differences. Alternatively, the function may include a ratio between functions of the sum of the first and second differences and a difference of the first and second differences.

In some example embodiments, the device 310 may transmit 3045 second information indicating the weight of the target positioning measurement to the device 320. In this case, the device 320 may perform 3050 the positioning estimation based on the weight. For example, the first device may determine the position estimation by using a weighted least squared algorithm. For example, if the device 320 obtains a first positioning measurement with a first weight and a second positioning measurement with a second weight, the device 320 may determine the position estimation by combining the first and second positioning measurements based on the first and second weights.

Alternatively, the device 310 may perform 3055 the positioning estimation based on the weight. For example, the first device may determine the position estimation by using a weighted least squared algorithm.

Example embodiments of the present disclosure may not require any labeled data, since it is unsupervised, and further, may not require multiple measurements (in real time) when assigning a weight for a given positioning measurement.

### Example Apparatus, Device and Medium

In some example embodiments, a first apparatus capable of performing any of the method 200 (for example, the device 110 or the device 120 in FIG. 1) may comprise means for performing the respective operations of the method 200. The means may be implemented in any suitable form. For example, the means may be implemented in a circuitry or software module. In some example embodiments, the first apparatus may be implemented as or included in the device 110 in FIG. 1. Alternatively, the first apparatus may be implemented as or included in the device 120 in FIG. 1.

In some example embodiments, the first apparatus comprises means for determining a set of channel features and a set of reference values associated with the set of channel features; means for determining at least one target channel feature from a target positioning measurement based on the set of channel features; means for determining a difference between the target positioning measurement and at least one reference value in the set of reference values based on the at least one target channel feature; and means for determining a weight for the target positioning measurement based on the difference.

In some example embodiments, the means for determining the set of channel features and the set of reference values associated with the set of channel features comprises: means for receiving from a second device first information indicating at least one of: the set of reference values and the set of channel features.

In some example embodiments, the first apparatus comprises means for transmitting to a second device a request for at least one of: the set of reference values and the set of channel features associated with the set of channel features.

In some example embodiments, the means for determining the set of channel features and the set of reference values associated with the set of channel features comprises:

means for determining the set of channel features from a set of measurements; means for clustering the set of channel features into a number of classes based on the set of channel features; and means for determining the set of reference values for the classes.

In some example embodiments, the first apparatus comprises means for performing a contradiction check on the set of reference values.

In some example embodiments, the means for determining the difference between the target positioning measurement and the at least one reference value comprises: means for determining a first difference between the target positioning measurement and a first reference value which is associated with line-of-sight channel; and means for determining a second difference between the target positioning measurement and a second reference value which is associated with non-line-of-sight channel.

In some example embodiments, the means for determining the difference between the target positioning measurement and the at least one reference value comprises: means for determining from the set of reference values a third reference value which is associated with a more line-of-sight-like channel than other reference values in the set of reference values; means for determining from the set of reference values a fourth reference value which is associated with a more non-line-of-sight-like channel than other reference values in the set of reference values; means for determining a third difference between the target positioning measurement and the third reference value; and means for determining a fourth difference between the target positioning measurement and the fourth reference value.

In some example embodiments, the means for determining the difference between the target positioning measurement and the at least one reference value comprises: means for determining differences between the target positioning measurement and a plurality of reference values in the set of reference values, respectively.

In some example embodiments, the means for determining the weight for the target positioning measurement comprises: means for determining the weight as a function of the difference.

In some example embodiments, the first apparatus comprises means for transmitting to a second device second information indicating the weight for determining a position estimation by the second device.

In some example embodiments, the first apparatus comprises means for determining a position estimation based on the weight.

In some example embodiments, the set of channel features comprises at least one of: a root mean square delay spread, a channel response or received waveform amplitude, a channel response or received waveform rise time, a channel response or received waveform kurtosis, a Rician K factor, an average energy of a channel response or received waveform, a total energy of the channel response or received waveform, an average amplitude of the channel response or received waveform, a total amplitude of the channel response or received waveform, a mean excess delay, a skewness of the channel response or received waveform, a standard deviation of the channel response or received waveform, or a standard variance of the channel response or received waveform.

In some example embodiments, the first device comprises one of: a first terminal device, a first core network device or a first network device; and the second device comprises one of: a second terminal device, a second core network device, or a second network device.

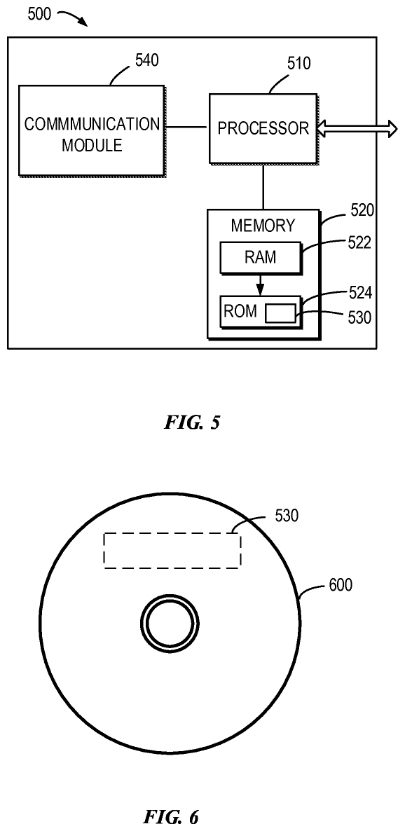

FIG. 5 is a simplified block diagram of a device 500 that is suitable for implementing example embodiments of the present disclosure. The device 500 may be provided to implement a communication device, for example, the device 110 or the device 120 as shown in FIG. 1. As shown, the device 500 includes one or more processors 510, one or more memories 520 coupled to the processor 510, and one or more communication modules 540 coupled to the processor 510.

The communication module 540 is for bidirectional communications. The communication module 540 has one or more communication interfaces to facilitate communication with one or more other modules or devices. The communication interfaces may represent any interface that is necessary for communication with other network elements. In some example embodiments, the communication module 540 may include at least one antenna.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The instructions of the program 530 may include instructions for performing operations/acts of some example embodiments of the present disclosure. The program 530 may be stored in the memory, e.g., the ROM 524. The processor 510 may perform any suitable actions and processing by loading the program 530 into the RAM 522.

The example embodiments of the present disclosure may be implemented by means of the program 530 so that the device 500 may perform any process of the disclosure as discussed with reference to FIG. 2 to FIG. 4. The example embodiments of the present disclosure may also be implemented by hardware or by a combination of software and hardware.

In some example embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 6 shows an example of the computer readable medium 600 which may be in form of CD, DVD or other optical storage disk. The computer readable medium 600 has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provides at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device comprising:
at least one processor; and
at least one memory storing instructions that, when executed by the at least one processor, cause the first device at least to perform:
determining a set of channel features and a set of reference values associated with the set of channel features;
determining at least one target channel feature from a target positioning measurement based on the set of channel features;
determining a difference between the target positioning measurement and at least one reference value in the set of reference values based on the at least one target channel feature; and
determining a weight for the target positioning measurement based on the difference.

2. The first device of claim 1, wherein determining the set of channel features and the set of reference values associated with the set of channel features comprises:
receiving from a second device first information indicating at least one of: the set of reference values and the set of channel features.

3. The first device of claim 1, wherein the first device is caused to perform:
transmitting to a second device a request for at least one of: the set of channel features and the set of reference values associated with the set of channel features.

4. The first device of claim 1, wherein determining the set of channel features and the set of reference values associated with the set of channel features comprises:
determining the set of channel features from a set of measurements;
clustering the set of channel features into a number of classes based on the set of channel features; and
determining the set of reference values for the classes.

5. The first device of claim 4, wherein the first device is caused to perform:
performing a contradiction check on the set of reference values.

6. The first device of claim 1, wherein determining the difference between the target positioning measurement and the at least one reference value comprises:
determining a first difference between the target positioning measurement and a first reference value which is associated with line-of-sight channel; and
determining a second difference between the target positioning measurement and a second reference value which is associated with non-line-of-sight channel.

7. The first device of claim 1, wherein determining the difference between the target positioning measurement and the at least one reference value comprises:
determining from the set of reference values a third reference value which is associated with a more line-of-sight-like channel than other reference values in the set of reference values;
determining from the set of reference values a fourth reference value which is associated with a more non-line-of-sight-like channel than other reference values in the set of reference values;
determining a third difference between the target positioning measurement and the third reference value; and
determining a fourth difference between the target positioning measurement and the fourth reference value.

8. The first device of claim 1, wherein determining the difference between the target positioning measurement and the at least one reference value comprises:
determining differences between the target positioning measurement and a plurality of reference values in the set of reference values, respectively.

9. The first device of claim 1, wherein determining the weight for the target positioning measurement comprises:
determining the weight as a function of the difference.

10. The first device of claim 1, wherein the first device is caused to perform:
transmitting to a second device second information indicating the weight for determining a position estimation by the second device.

11. The first device of claim 1, wherein the first device is caused to perform:
determining a position estimation based on the weight.

12. The first device of claim 1, wherein the set of channel features comprises at least one of:
a root mean square delay spread,
a channel response or received waveform amplitude,
a channel response or received waveform rise time,
a channel response or received waveform kurtosis,
a Rician K factor,
an average energy of a channel response or received waveform,
a total energy of the channel response or received waveform,
an average amplitude of the channel response or received waveform,
a total amplitude of the channel response or received waveform,
a mean excess delay,
a skewness of the channel response or received waveform,
a standard deviation of the channel response or received waveform, or
a standard variance of the channel response or received waveform.

13. The first device of claim 1, wherein the first device comprises one of: a first terminal device, a first core network device or a first network device; and
wherein the second device comprises one of: a second terminal device, a second core network device, or a second network device.

14. A method comprising:
determining, at a first device, a set of channel features and a set of reference values associated with the set of channel features;
determining at least one target channel feature from a target positioning measurement based on the set of channel features;
determining a difference between the target positioning measurement and at least one reference value in the set of reference values based on the at least one target channel feature; and
determining a weight for the target positioning measurement based on the difference.

15. The method of claim 14, wherein determining the set of channel features and the set of reference values associated with the set of channel features comprises:
receiving from a second device first information indicating at least one of: the set of reference values and the set of channel features.

16. The method of claim 14, further comprising:
transmitting to a second device a request for at least one of: the set of channel features and the set of reference values associated with the set of channel features.

17. The method of claim 14, wherein determining the set of channel features and the set of reference values associated with the set of channel features comprises:
determining the set of channel features from a set of measurements;
clustering the set of channel features into a number of classes based on the set of channel features; and
determining the set of reference values for the classes.

18. The method of claim 17, further comprising:
performing a contradiction check on the set of reference values.

19. The method of claim 14, wherein determining the difference between the target positioning measurement and the at least one reference value comprises:
determining a first difference between the target positioning measurement and a first reference value which is associated with line-of-sight channel; and
determining a second difference between the target positioning measurement and a second reference value which is associated with non-line-of-sight channel.

20. The method of claim 14, wherein determining the difference between the target positioning measurement and the at least one reference value comprises:
determining from the set of reference values a third reference value which is associated with a more line-of-sight-like channel than other reference values in the set of reference values;
determining from the set of reference values a fourth reference value which is associated with a more non-line-of-sight-like channel than other reference values in the set of reference values;
determining a third difference between the target positioning measurement and the third reference value; and
determining a fourth difference between the target positioning measurement and the fourth reference value.

21-28. (canceled)
